(19) United States
(12) Patent Application Publication
(10) Pub. No.: US 2021/0065304 A1
(43) Pub. Date: Mar. 4, 2021

(54) CONTRACT AUTOMATION WITH BLOCKCHAIN BASED INTERACTION AND RECORDING

(71) Applicants: William Greene, San Francisco, CA (US); Thomas Neeley, San Francisco, CA (US); Amanda Li, San Francisco, CA (US)

(72) Inventors: William Greene, San Francisco, CA (US); Thomas Neeley, San Francisco, CA (US); Amanda Li, San Francisco, CA (US)

(21) Appl. No.: 16/558,996

(22) Filed: Sep. 3, 2019

(51) Int. Cl. G06Q 40/06; G06Q 20/38; G06F 17/27; G06F 17/21; G06F 17/22

(52) U.S. Cl. CPC G06Q 40/06; G06Q 20/389; G06N 20/00; G06F 17/218; G06F 17/2205; G06F 17/2705

(57) ABSTRACT

The systems, apparatus, methods, and computer program products described herein provide the capability to convert physical debt instruments into digital representations, and to completely manage all aspects of the instruments lifecycle digitally. This allows for real-time update of debt clauses and covenants at a very low cost. Furthermore, the digital representations create immutable histories, which simplify and streamline the process of auditing, confirming legal compliance, and performing due diligence for syndication or securitization. The systems, apparatus, methods, and computer program products described herein further provide automatic updates of key metrics from disparate data sources, notarization of contractual changes, and automated disbursement of funds or creation of new asset classes.

### CROSS-REFERENCE TO RELATED APPLICATIONS

This application claims the benefit under 35 USC 119(e) and priority under 35 USC 120 to U.S. Provisional Patent Application No. 62/726,106, filed Aug. 31, 2018 and titled “Contract Automation with Blockchain Based Interaction and Recording,” the entirety of which is incorporated herein by reference.

### BACKGROUND OF THE INVENTION

### Field of the Invention

The present invention generally relates to autonomous tracking and enforcement of contractual requirements contained in loan agreements and other debt instruments that are used to finance the construction and operation of renewable energy systems and other infrastructure projects. The present invention further utilizes distributed ledgers, smart contract systems, and natural language encoding.

### Description of the Related Art

Global energy systems and other similar infrastructure projects have historically focused on single, large scale developments with financial needs in the billions of dollars. However, the new preferred approach, with an increased focus on sustainable and renewable energy sources, is to build many smaller distributed energy systems, typically with costs of only a few million dollars. This has created challenges in the financing industry for these developments as the methods, software, and systems for originating, monitoring, servicing, and syndicating these financial instruments are static, reactive, periodic, and complex. They rely in large part on data collected in non-interoperable systems and human expertise and labor to combine, interpret, and create periodic reports against bespoke contracts with contractual requirements tailored to individual projects. As a result, the costs of debt financing over the lifetime of the development project is only reasonable when amortized over very large-scale projects, and cost prohibitive for these new, smaller, distributed projects.

The current public blockchain infrastructure provides a distributed payment platform. Each transaction is validated and permanently recorded in the blockchain, and some blockchain providers have introduced smart contract functionality (such as the ERC20 token) where the blockchain can provide the status of contractual requirements. However, the use of blockchain to solve the financing problem for small-scale infrastructure projects has not been possible for several reasons. First, the economic cost of validating transactions through the blockchain network is very high. Second, multiple financial and operational inputs from numerous sources must still be manually interpreted, verified, and agreed to by all contractual parties before updating the smart contract. Finally, blockchain smart contracts do not overcome informational disparity between the seller of a loan and a potential buyer. As a result, auditing the historical performance of the loan remains a manual process by a potential buyer which greatly decreases the market liquidity of these loans.

In current loan arrangements, multiple counterparties maintain their own informational systems, and discrepancies in the value of data collected about the loan, the interpretation of that data, and whether contractual requirements have been met often occurs. In these cases, counterparties must perform manual ad hoc reconciliation to reach consensus on the differences. Furthermore, the reasons and results of these ad hoc negotiations are not consistently recorded and available for the life of the debt instrument.

### BRIEF SUMMARY OF THE INVENTION

The present invention is a method, system, and computer program that utilizes distributed ledgers and smart contract systems to encode natural language contractual clauses into smart contracts that may be interconnected to disparate data sources, including Internet of Things (IoT) devices. These sources provide data to determine or trigger the contractual states of clauses in the underlying loan or debt instrument. The present invention provides consistent, real-time tracking and enforcement of contractual clauses for all counterparties. It also provides historical context on contractual data between the parties, and for potential asset buyers.

### BRIEF DESCRIPTION OF THE SEVERAL VIEWS OF THE DRAWING

The details of the present disclosure, both as to its structure and operation, can best be understood by referring to the accompanying drawings, in which like reference numbers and designations refer to like elements.

FIG. 1 is an exemplary component level block diagram of the major functional components in which the system, method, and computer program product described herein may be implemented, along with the entities and artifacts involved in the contract system interactions;

FIG. 2 is an exemplary block diagram of the components used to encode and store debt instruments;

FIG. 3 is an exemplary block diagram of the components used to request, receive, and process data from external sources related to the debt instrument and its project;

FIG. 4 is an exemplary block diagram of the components used to interface with the other components of the system;

FIG. 5 is an exemplary flow diagram of the method for creating a digital representation for a debt instrument;

FIG. 6 is an exemplary flow diagram of the method for maintaining the digital representation of a debt instrument; and

FIG. 7 is an exemplary flow diagram of the method for interacting with the digital representation of a debt instrument.

### DETAILED DESCRIPTION OF THE INVENTION

The system, method, and computer program product described herein allows contract participants to automatically manage the full lifecycle of a debt instrument in a low cost and real-time fashion.

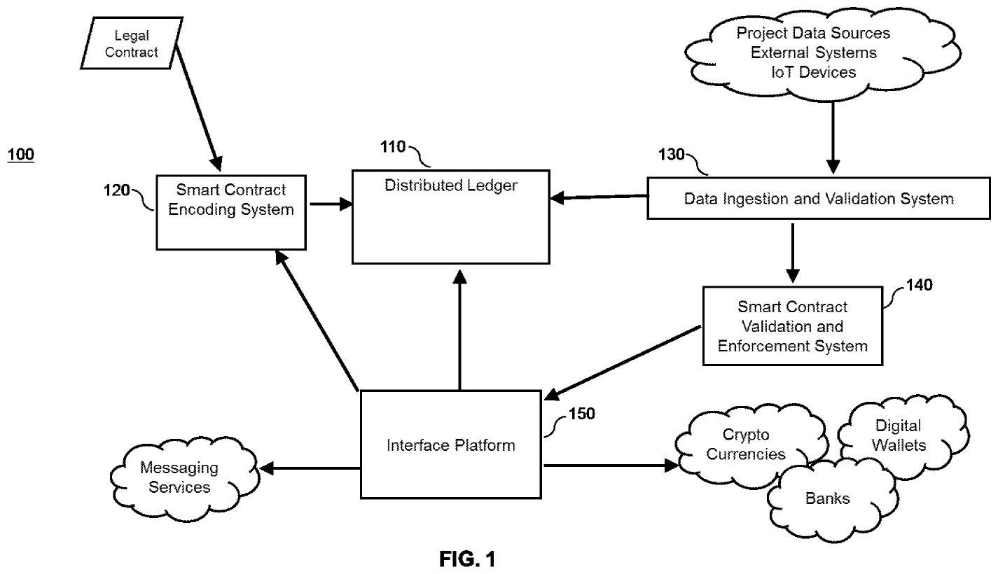

Referring now to FIG. 1, an example of a system 100 in which the system, method, and computer program product described herein may be implemented, along with the entities and artifacts involved in the contract system interaction, is shown. It includes, but is not limited to, distributed ledger 110, smart contract encoding system 120, data ingestion and validation system 130, smart contract validation and enforcement system 140, and interface platform 150.

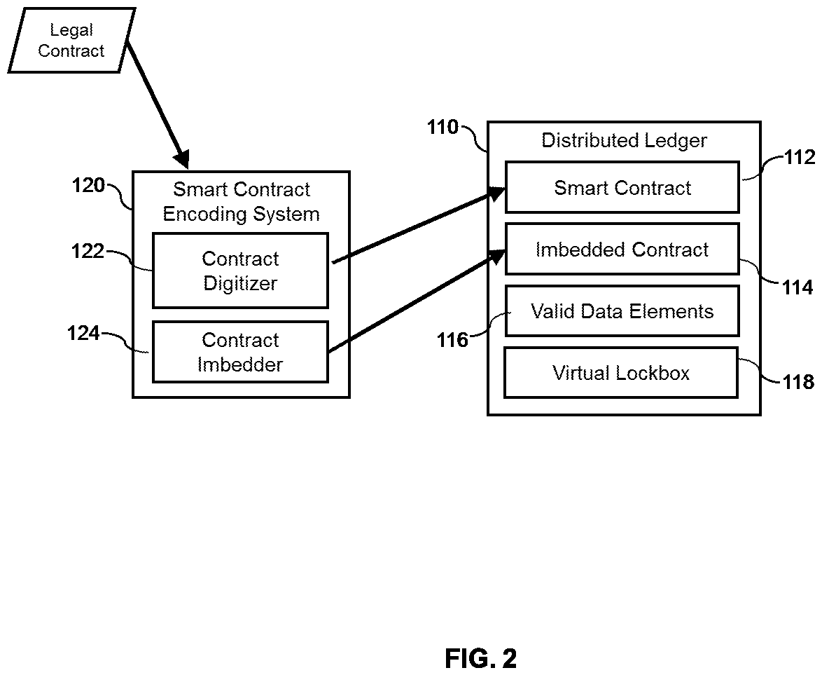

Referring now to FIG. 2, the means for digitally encoding and storing an original legal document is illustrated. Distributed ledger 110 is a decentralized database replicated across multiple nodes in a peer-to-peer network, where each node uses consensus algorithms to ensure the validity and integrity of the ledger. In some embodiments, distributed ledger 110 could be either a public or private blockchain system. Distributed ledger 110 is used to store smart contracts 112, imbedded contract 114, valid data elements 116, and virtual lockbox 118. Smart contracts 112 contain algorithmic instructions that encode contractual clauses. In some embodiments, smart contracts 112 contain a collection of boolean conditions that determine if contract clauses have been fulfilled. Imbedded contract 114 is a digital human-readable copy of the original legal contract text for the debt instrument. In some embodiments, imbedded contract 114 contains machine-readable cross-references to the algorithmic instructions on smart contracts 112 in addition to the human-readable text. Valid data elements 116 contains zero or more entries which have validated data values which can be used by the algorithmic instructions in smart contracts 112 to compute the status of contractual clauses of the debt instrument. In some embodiments, valid data elements 116 are notarized using cryptographic methods which provide proof of authenticity, including, but not limited to digital signatures of the notarizing agent. The notarizing agent can be either a human or a machine process. In some embodiments, valid data elements 116 contain not only the present values for data, but also date-stamped historical values for data. Virtual lockbox 118 provides a mechanism for receiving and transmitting funds through electronic connections to banks, crypto currency, and digital wallets. In some embodiments, virtual lockbox 118 is a smart contract with computational loads that specify conditions where funds may be transfers and the parties to those transfers.

Smart contract encoding system 120 provides the digital encoding and storage of an original legal document which describes the characteristics, covenants, provisions, and other details of the debt instrument. Processing of original documents by smart contract encoding system 120 is provided by contract digitizer 122 and contract imbedder 124. Contract digitizer 122 converts digital representations of a paper document, for example a digital scan, into a set of algorithmic instructions that may be executed to determine the status of the contract's stipulations. In some embodiments, contract digitizer 122 is implemented using natural language processing and machine learning. In those embodiments, through machine learning against a repository of thousands of seed documents with a wide variety of different expressions for clauses, the system can be trained to use natural language processing to reduce normal written language into digital equivalents. Once contract digitizer 122 has generated digital equivalents, it creates smart contracts 112 in distributed ledger 110. In some embodiments, contract digitizer 122 creates a single smart contract 112 for each individual clause in the original document. This allows for smart contract 112 for an individual clause to be invalidated or replaced without affecting the operation of other smart contracts 112 in the same document. Moreover, since distributed ledger 110 does not allow deletion of smart contracts 112 but only invalidation, distributed ledger 110 may be used to recreate a history of the contract, with changes in debt clauses, covenants, and processing instructions identified over the life of the debt instrument. After the entire document has been processed by contract digitizer 122, contract imbedder 124 stores imbedded contract 114 in distributed ledger 110.

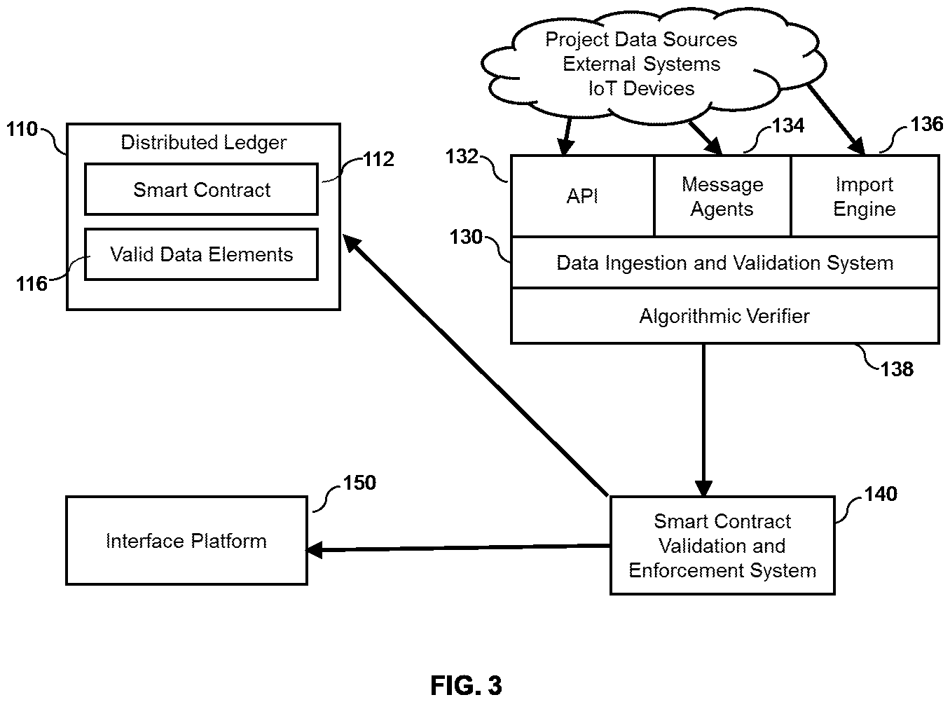

Referring now to FIG. 3, the means for electronically requesting, receiving, and validating data, and the means for processing and storing validated data are illustrated. Data ingestion and validation system 130 electronically requests, receives, and validates data related to project performance from disparate data sources. These sources could include financial, operational, and management systems used by project implementors, the borrower, the lender, and other parties to the debt instrument or involved with the project. Data sources could also include Internet of Things (IoT) devices that provide real time monitoring of work in progress, or in outputs from the project. Data collected could come from a multitude of sources to cover any conditions that have been built into the clauses of the debt instrument. This may include system data from outside the project and standard financial systems; for example, climate change and other environmental, social, and governance (ESG) measurements could be retrieved to generate green energy compliance metrics. Data ingestion and validation system 130 requests and receives data using API 132, message agents 134, and import engine 136. In some embodiments, API 132 supports incoming data through a uniform programmatic interface that specifies how external systems can provide the identification of the data, the classification of the data, and the data value. In some embodiments, API 132 provides an outgoing extension to request data from eternal systems. API 132 specifies the programmatic structure of the data and allows computer programs to be written which can vary between external systems, but once developed can be re-used for multiple different external systems of the same type. Message agents 134 implements an incoming message listener that can process common computer messaging protocols to allow external systems to provide data via messaging. Import engine 136 provides an option for external systems which do not have their own network accessible API, cannot write to the incoming interface of API 132, and do not have messaging capability. In this case, data may be exported from the external system in common file formats, for example comma separate value (CSV) files. Import engine 136 reads data from these exported files, and converts it into the internal data structures used in API 132. In some embodiments, data ingestion and validation system 130 receives or polls data on a regular, scheduled basis. In some embodiments, data ingestion and validation system 130 receives data in real-time from network connected external devices and systems Once data ingestion and validation system 130 has data, algorithmic verifier 138 compares newly received data with previously received data to establish a confidence rating for the validity of the data. When data conflicts between two external sources, it receives a lower confidence score. Algorithmic verifier 138 enforces a minimum confidence level for data, and data which does not meet this requirement can be flagged for manual verification and possible correction. Data ingestion and validation system 130 provides the capabilities to receive data from disparate systems and devices, including those which use common well understood protocols, those implementing new protocols, and those without any communications protocol at all.

Smart contract validation and enforcement system 140 takes validated data from data ingestion and validation system 130 and processes it and stores it in valid data elements 116 of distributed ledger 110. Smart contract validation and enforcement system 140 also retrieves smart contracts 112 associated with the debt instrument, filters them to find ones that use the validated data in their algorithmic instructions. These algorithmic instructions are executed, which may result either in additional computed data values, or in changes in the boolean status of the clause that is represented by that specific smart contract 112. If additional data values are computed (for example, computing the debt service coverage ratio when new data is received for revenue, expenses, or principal and interest payments), then smart contract validation and enforcement system 140 may store these values in valid data elements 116. If contract status changes occur, then smart contract validation and enforcement system 140 may take actions specified in the contract clauses and encoded in smart contracts 112; for example, payment disbursements may be made, notifications can be sent to debt instrument parties, or additional conditional clauses encapsulated in smart contracts 112 may be activated or deactivated. In embodiments where valid data elements 116 are notarized or date-stamped, smart contract validation and enforcement system 140 digitally signs and dates the data, whether received from data ingestion and validation system 130 or computed by smart contract validation and enforcement system 140, before storage in valid data elements 116.

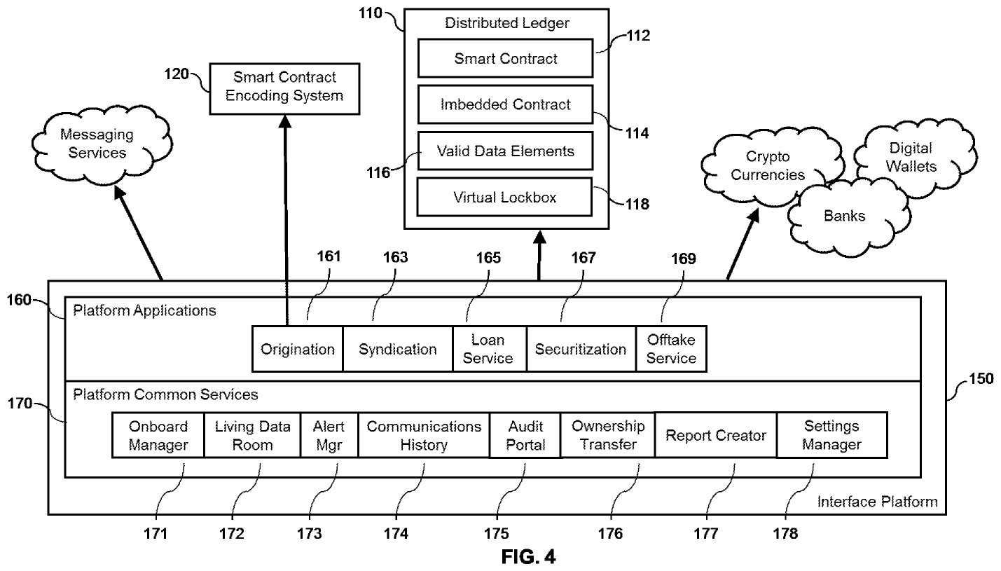

Referring now to FIG. 4, the means for interfacing the system to external users and non-data systems is illustrated. Interface platform 150 contains platform applications 160 and platform common services 170 which together provide the interface for the system to external users and non-data systems such as messaging/notification systems and electronic financial systems. Platform applications 160 provides user facing functionality for the parties of the debt instrument (the lender and borrower). These include, but are not limited to, origination app 161, syndication app 163, loan servicing app 165, securitization app 167, and offtake servicing app 169. In some embodiments, platform applications 160 is a cloud-based software solution providing a graphical user interface with customer authentication granting access to different functionalities associated with debt instruments that system 100 is managing for that customer (lender, borrower, other debt instrument party, or third party auditor). Origination app 161 allows borrowers and lenders to collaboratively set up debt instrument contract terms and facilitates closing the loan, including building a loan from standard loan clauses, and finalizing the items on a closing checklist. Syndication app 163 allows a lender to quickly syndicate a portfolio of loans from creation and underwriting to syndication. It also allows management of the syndicated portfolio. Loan servicing app 165 allows borrowers and lenders to manage and have a shared understanding of current and historical loan performance. In some embodiments, loan servicing app 165 can use historic models for this and other debt instruments to project future performance of the debt instrument. Securitization app 167 allows the lender to create a portfolio of debt instruments to create a security. Once the security is created, securitization app 167 provides management of risk, fund flow, and compliance functions. In some embodiments, securitization app 167 provides specialized tools for green funds management, including specialized regulatory and compliance tools. Offtake servicing app 169 provides functionality to support offtake agreements, so that project owners can effectively monetize the future production of their projects. This includes tools that manage disbursements of revenue, reporting of actual production vs. goals, price fluctuations in the production market, and operating metrics. Platform applications 160 rely on platform common services 170 to provide functions that are used across multiple applications. The common services include, but are not limited to, onboard manager 171, living data room 172, alert manager 173, communications history 174, audit portal 175, ownership transfer portal 176, report creator 177, and settings manager 178. Onboard manager 171 provides functionality for create new debt instruments by interacting with smart contract encoding system 120 to create smart contracts 112 and store the original legal document in imbedded contract 114. Living data room 172 ensures that loan statuses are kept-up-to-date by pulling algorithmic instructions from smart contracts 112 and the most recent data from valid data elements 116. The data room can then recompute the statuses and metrics for debt instruments (or securities, or syndicates composed of multiple debt instruments), store updated values in valid data elements 116, and display this information for one or more parties to the debt instrument, security, or syndicate. Communications history 174 maintains a history of communications to parties of the debt instrument. This is primarily intended to be a legal proof of notification, messaging, and multi-party decisions. In this way, the system may serve as a system of record for votes, decisions, and waivers around financial, operational, and ownership decisions. In some embodiments, communications history 174 is implemented by storing communication events in distributed ledger 110 and retrieving those events when required for reporting or audit purposes. Audit portal 175 provides a reporting interface so that borrowers, lenders, and third-party auditors can access historical contractual states, decisions, and transactions to ensure compliance with contractual terms and legal requirements. In some embodiments, audit portal 175 is a cloud-based web application which provides a graphical user interface for this data. Ownership transfer portal 176 provides the capability to transfer ownership of financial assets, and displays visualization of the digital ownership of debt instruments, securities, and syndicates represented by smart contracts 112. When ownership changes are invoked through the user interface, ownership transfer portal 176 confirms that requirements for financial asset transfer, as indicated by clauses digitally represented in smart contracts 112, have been met. For cases when transfer of ownership rights implies funds transfer, ownership transfer portal 176 connects to networked digital banks, cryptocurrencies, and digital wallets to effect the funds transfer. Report creator 177 allows system 100 users to create reports that are run immediately, on demand at a future point, or scheduled for periodic execution. When reports are run, report creator 177 connects to smart contracts 112 to harvest valid data about contracts, including metrics, contractual clause statuses, and other digitized data. These pieces of data are combined into report templates stored by report creator 177 to generate a final report. The final report is able to be viewed by customers through connection to interface platform 150, or may be transmitted to customers using living data room 172 and communications history 174. In some embodiments, reports are stored in digital ledger 110. Settings manager 178 provides a storage mechanism for individual users of the system to configure their preferences, user specific biographical data, security and billing information. Settings manager 178 provides a store which is used generally by interface platform 150 to provide authentication, security, and correlation with offline and external digital references for a customer. The capabilities of platform common service 170 are also exposed via common services API 180 to other parts of system 100. For example, when a debt instrument clause changes status, smart contract validation and enforcement system 140 uses platform common services 170 for alerting parties, updating the legal history of communications, and establishing an audit trail of the event. In similar fashion, virtual lockbox 118 uses ownership transfer portal 176 to transfer ownership of financial assets, causing funds transfer in connected electronic banking systems, crypto-currencies, or digital wallets.

The use of distributed ledger 110 as the storage for all activity in the system allows the system to maintain a comprehensive history of events within the system, the actors that caused those events, and parties that were approvers of the events. These events could be received data, computed metrics, automatic clause updates, manual mutually agreed upon clause updates, reports, messaging and notification, or asset distribution, among others. All these events are stored in distributed ledger 110 with a complete history that allows third party auditors or new parties to the contractual relationship to easily and quickly perform sophisticated analysis and due diligence.

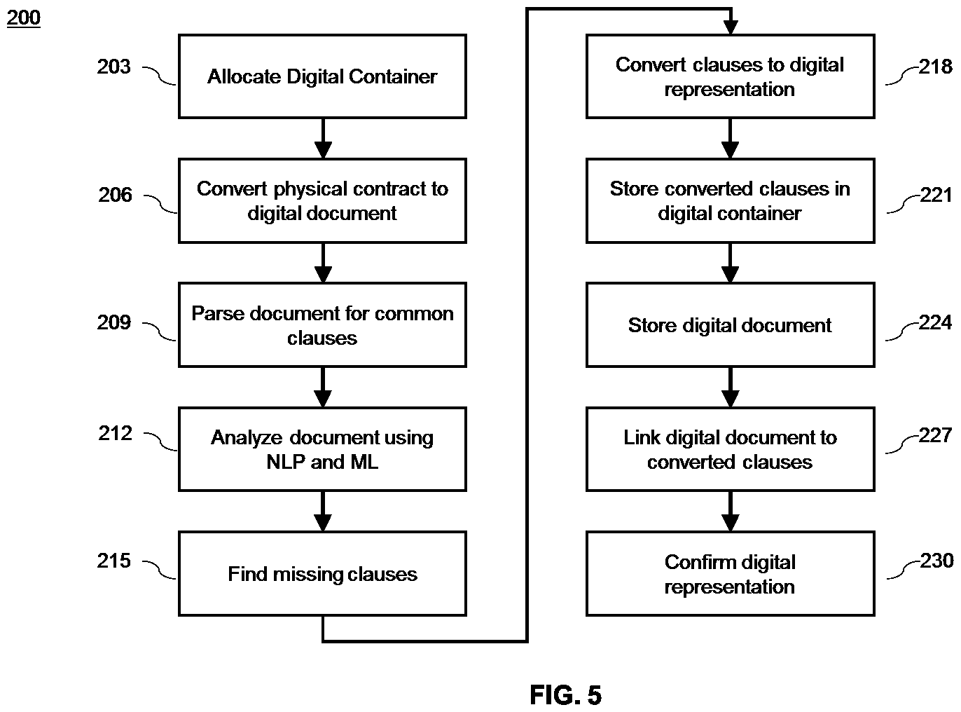

Referring now to FIGS. 5-7, the method for servicing a physical legal debt instrument over its entire lifecycle using a low cost, real time, digital equivalent is illustrated.

FIG. 5 depicts the method 200 for creating a digital representation of the physical debt instrument. In 203, a digital container is allocated for storing the digital representation of the debt instrument. In 206, the physical contract is converted into a digital document using optical character recognition or a similar technology. In 209, the document is parsed for common clauses and phrases that follow standard grammatical constructions to find key financial, operational, or legal concepts. In 212, a trained natural language processor or machine learning algorithm is used to analyze the document for non-standard phraseology that indicates clauses related to key concepts. In 215, the digital representation of the document created in 206 is annotated to indicated which words have been associated with found clauses in 209 and 212. If clusters of words of a certain size or larger exist in the document, it indicates that there is the potential for a missed clause. In this case, human assisted rescan may be performed, and used to further train the machine learning algorithm used in 212. In 218, each identified clause is converted in digital representation. The digitized clauses may encode specific assertions of value, for instance, a clause may indicate the name of the lender. They may encode computational instructions, for example, how to calculate the debt service coverage ratio from underlying revenue, expenses, principal payments, and interest payments. They may encode conditional instructions for computing boolean conditions of the debt instrument, for example, whether the loan is in default could be computed based on the underlying payment schedule and actual payments received. Finally, they may encode complex procedural instructions to be executed when prescribed conditions are met; for example, the disbursement of funds in tiers to multiple parties upon reaching specific performance levels. In 221, the digital clauses are stored in the digital container allocated in 203. In some embodiments, this step is implemented through creation of smart contracts in a distributed ledger. In some embodiments, each clause is stored individually so that it can be modified or removed separately from digital representations of other clauses. In 224, the digital document of the original physical contract created in 206 is stored in the digital container allocated in 203. In some embodiments, after storing the digital document in 224, then the digital document is marked up in 227 with references that digitally link to the individual digital clauses stored in 221. This allows for expeditious computation and retrieval of all clauses associated with a specific debt instrument as well as the ability to visually display these linkages for customers. It also correlates legal language to digital representations of contract terms for rights and obligations enforcement in courts of law. As a final step, in 230, the parties of the debt instrument confirm the digital representation. This may occur through a simple confirmation, or by requiring digital cryptographic signatures which can be stored as a permanent digital record of the attestation.

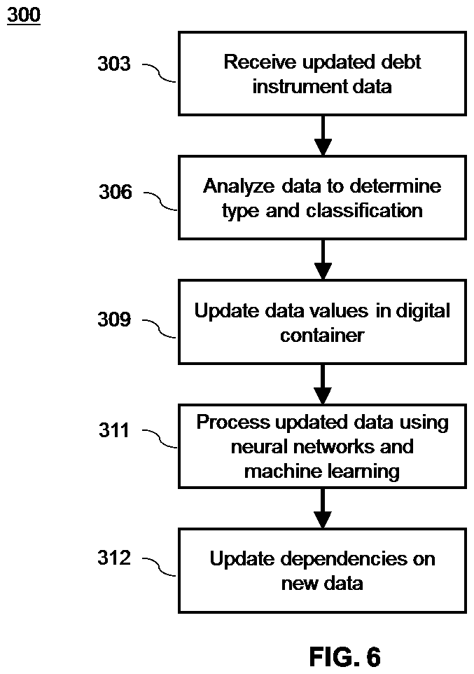

Referring now to FIG. 6, the method for maintaining the digital representation for a debt instrument 300 is illustrated. Maintaining the digital representation allows for real-time automatic responses to changing conditions in the underlying debt instrument, in the project being financed, or in the marketplace over the entire lifecycle of the debt instrument.

In 303, updated debt instrument data is received electronically. This may happen in a number of ways, including, but not limited to, API calls from electronically connected external systems, digital messaging from external systems, import of data dumps generated by external systems, and manual data updates, for example by customers using internal applications. In some embodiments, updated loan data is received electronically in an automatic, near real time fashion. This is achieved by instrumenting real time operations in external systems to use API calls to the internal system, by subscribing to real time messaging on external systems, or by using periodically scheduled automated data dumps to drive import processes. In 306, the received loan data is analyzed to determine its type and classification. In some embodiments, the received loan data is further notarized by parties for legal purposes. This can be done automatically through digital signing within the internal system, or by requiring a party (lender, borrower) to log in to the internal system and use their credentials, such as an X.509 certificate, to identify themselves and digitally sign the received data. In 309, the analyzed data, and notarization if applicable, are used to update values in the digital container created in 203. This storage of data is done using the same methodology of 218, with the newly received analyzed data treated as an assertion of value. In some embodiments, once the data is updated in 309, then this updated data may be processed, in 311, through neural networks or machine learning algorithms resulting in calculated credit risk, probability of default, expected recovery rates, and other predictive metrics. In 312, dependencies in the digital representation are updated by determining clauses that depend on the data type and classification determined in 306, retrieving dependent clauses previously stored in 218, and executing their computational instructions. The computational instructions may specify simply updating further dependent values, which occurs as in 309, may specify that messaging or notification be performed to one or more parties of the debt instrument, may specify the transfer of assets (including monetary funds or other digital representations created as in FIG. 2), or may instantiate new clauses via 218. In this way, the method allows modification of any part or the entirety of the digital representation, allows control over modification through a notification and approval processes, and allows ownership transfer or the creation of subsidiary debt instruments when required financial or operational requirements are met. Furthermore, this allows for the release of capital funds based on real-time information rather than relying on pre-calculated metrics, generalized industry norms, or static projections. The sequence of steps for maintaining the digital representation for the underlying debt instrument 300 is repeated over the lifetime of the debt instrument as new data becomes available, either in real time, or on-demand.

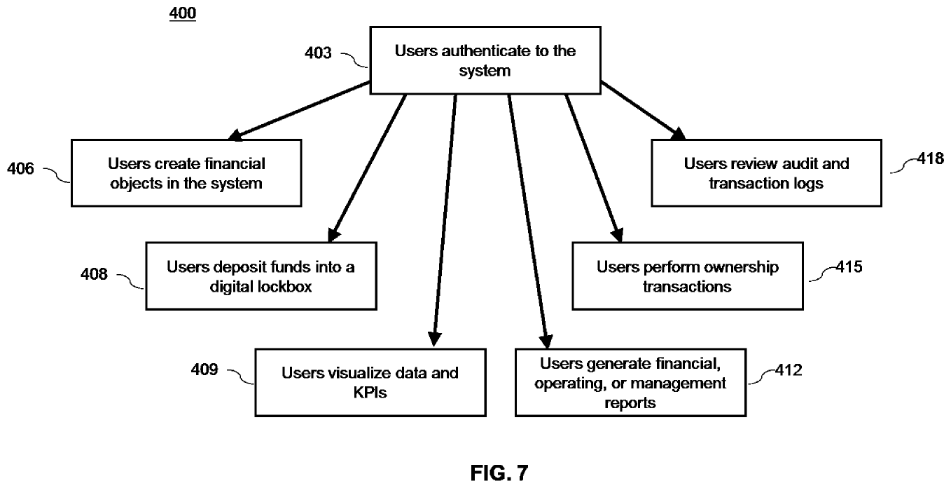

Referring now to FIG. 7, the method for manually interacting with the digital representation of the debt instrument 400 is provided. Manual interactions include, but are not limited to, allowing borrowers or lenders to view the state of the debt instrument at any time; to add, delete, or modify clauses under control of the debt instrument's modification covenants; to create combinations of debt instruments as a syndicate; to create new digital assets based on ownership of a debt instrument's underlying project cash flows; and to view historical data and metrics.

In 403, users (borrowers, lenders, third party agents including auditors, syndicate members, and potential asset purchasers) authenticate to the system. Authentication may happen by various means including, but not limited to, username/password, X.509 certificate based, or multi-factor authentication. After authenticating in 403, users may do a variety of actions. In 406, users create instruments, syndications, or securitized assets. The creation is done by providing an interface that collects the information required to initiate the flow 200. In 408, users may deposit funds into a digital lockbox, where fund disposition can be controlled automatically by contractual clauses specified in 218. In 409, users may visualize data and key performance indicators for an active debt instrument. This includes viewing the state of individual data values, viewing a historical list of values, viewing multiple data elements in a concise single page dashboard, and viewing time series of one or more data elements through graphs and tables. Visualization 409 also allows for users to create their own displays consisting of overlaying data from various clauses of the debt instrument. This allows users to create customized graphs and tables of information that may not be apparently related for trend analysis and advanced risk, financial, or operational evaluation. In 412, users may generate reports by creating a customized report template, selecting the date range for the data, and choosing whether to display the report or forward it for external consumption. In 415, users may initiate, approve, or review ownership transfers. This includes the partial or complete ownership transfer of an entire debt instrument as well as ownership transfer of digital representations of future or present financial interests in the debt instrument. In 418, users may review the audit and transaction logs for the debt instrument, including notarization of data elements and calculated metrics. This allows third party auditors to ensure legal compliance with the debt instrument's covenants.

The description of the present invention has been provided for purposes of illustration and description, but is not intended to be exhaustive or to limit the invention solely to the form disclosed. As used herein, the singular forms “a”, “an”, and “the” are intended to include the plural forms as well unless otherwise specifically indicated. It will be further understood that the terms “includes”, “including”, “comprises”, “comprising” specify the presence of stated components, systems, steps, or processes, but do not preclude the addition of one or more other components, systems, steps, or processes. It will be further understood that the terminology “loan” and “debt instrument” indicate an underlying financial contractual obligation between two or more parties, and are used interchangeably. Many modifications and variations will be apparent to those of ordinary skill in the art without departing from the scope and spirit of the invention. The embodiment was chosen and described in order to best explain the principles of the invention and its practical applications, and to enable others of ordinary skill in the art to understand the invention and its embodiments that might be best suited for specific contemplated uses.

What is claimed is:

1. A method for managing the complete life cycle of a physical debt instrument comprising:
A first step of creating a digital representation of said instrument further comprising:
Allocating a digital container;
Analyzing said instrument using natural language processing or machine learning algorithms;
Creating digitized clauses; and
Storing digitized clauses;
A second step of maintaining said digital representation further comprising:
Receiving updated debt instrument data electronically; and
Updating values in said digital container; and
A third step of interacting with said digital representation further comprising:
Creating instruments, syndications, and securitized assets; and
Visualizing data and key performance indicators for said digital representation.

2. A method as in claim 1, wherein a first step of creating a digital representation further comprises:
Converting said debt instrument into a digital document;
Parsing said instrument using standard clauses;
Detecting uninterpreted clauses and updating the natural language processor;
Storing said digital document; and
Confirming digital representation by all contractual parties.

3. A method as in claim 1 wherein said digitized clauses encode assertions of value, computational instructions, conditional instructions, or procedural instructions.

4. A method as in claim 1 wherein storing digitized clauses further uses smart contracts in a distributed ledger.

5. A method as in claim 1 wherein storing digitized clauses requires each clause be stored separately to allow independent modification.

6. A method as in claim 2 wherein storing digital document further comprises marking up said document to link with separately stored digital clauses.

7. A method as in claim 2 wherein confirming digital representation uses digital cryptographic signatures to create a permanent record of attestation.

8. A method as in claim 1 wherein a second step of maintaining said digital representation further comprises:
Analyzing received data to determine type and classification; and
Updating dependencies in said digital representation.

9. A method as in claim 1 wherein said updated debt instrument data is received by API, messaging, data dump imports, and manual updates.

10. A method as in either claim 9, wherein said step of receiving updated debt instrument data occurs in near real time.

11. A method as in claim 1 wherein a third step of interacting with said digital representation further comprises:
Authenticating to the system;
Generating reports;
Initiating, approving, and reviewing ownership transfers; and
Reviewing the audit and transaction logs.

12. A system for automatically managing the full lifecycle of a debt instrument comprising:
a decentralized database;
a means for digitally encoding and storing an original legal document in said decentralized database:
a means for electronically requesting, receiving, and validating data related to said debt instrument;
a means for processing and storing validated data in said decentralized database; and
a means for interfacing the system to external users and non-data systems.

13. A system as in claim 12 wherein said decentralized database is a distributed ledger.

14. A system as in claim 13 wherein said distributed ledger is a public or private blockchain.

15. A system as in claim 12 wherein said decentralized database stores smart contracts that encode contractual clauses from said debt instrument, a digital human-readable imbedded contract, valid data elements for contractual clauses, and a virtual lockbox to receive and transmit funds through electronic connections.

16. A system as in claim 15 wherein said contractual clauses are a collection of boolean conditions.

17. A system as in claim 15 wherein said valid data elements are notarized using cryptographic means.

18. A system as in claim 15 wherein said virtual lockbox is a smart contract.

19. A system as in claim 12 wherein said requesting, receiving, and validating means comprises:
an API that allows programmatic implementation;
message agents which can process common messaging protocols; and
an import engine that allows import of data from files with common file formats.

20. A system as in claim 12 wherein said validating data means further comprises a means for establishing a confidence rating for the validity of incoming data.

21. A system as in claim 12 wherein said processing and storing means further comprises a means for executing algorithmic instructions of clauses of the debt instrument.

22. A system as in claim 12 wherein said processing and storing means further comprises a means for digitally signing and dating received data.

23. A system as in claim 12 wherein said interfacing means further comprises:
a means for collaboratively setting up debt instrument contract terms;
a means for syndicating a portfolio of debt instruments;
a means for projecting future performance of the debt instrument;
a means for creating a portfolio of debt instruments to create a security;
a means for creating smart contracts;
a means for precomputing the statuses and metrics for debt instruments;
a means for maintaining a history of legal communications;
a means for ensuring compliance with contractual terms and legal requirements;
a means for transferring ownership of financial assets; and
a means for creating reports.
